(19) United States
(12) Patent Application Publication
(10) Pub. No.: US 2017/0091619 A1
(43) Pub. Date: Mar. 30, 2017

(54) SELECTIVE BACKPROPAGATION

(71) Applicant: QUALCOMM Incorporated, San Diego, CA (US)

(72) Inventors: Regan Blythe TOWAL, La Jolla, CA (US); David Jonathan JULIAN, San Diego, CA (US)

(21) Appl. No.: 15/081,780

(22) Filed: Mar. 25, 2016

Related U.S. Application Data
(60) Provisional application No. 62/234,559, filed on Sep. 29, 2015.

(51) Int. Cl. G06N 3/08; G06N 3/04

(52) U.S. Cl. CPC G06N 3/084; G06N 3/0472

(57) ABSTRACT

The balance of training data between classes for a machine learning model is modified. Adjustments are made at the gradient stage where selective backpropagation is utilized to modify a cost function to adjust or selectively apply the gradient based on the class example frequency in the data sets. The factor for modifying the gradient may be determined based on a ratio of the number of examples of the class with a fewest members to the number of examples of a present class. The gradient associated with the present class is modified based on the above determined factor.

### CROSS-REFERENCE TO RELATED APPLICATION

The present application claims the benefit of U.S. Provisional Patent Application No. 62/234,559, filed on Sep. 29, 2015, and titled “SELECTIVE BACKPROPAGATION,” the disclosure of which is expressly incorporated by reference herein in its entirety.

### BACKGROUND

Field

Certain aspects of the present disclosure generally relate to machine learning and, more particularly, to modifying the balance of training data between classes for a machine learning model.

Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using backpropagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In one aspect, a method of modifying a balance of training data between classes for a machine learning model is disclosed. The method includes modifying gradients of a backpropagation process while training the model, based on a ratio of a number of examples of a class with a fewest members to a number of examples of a present class.

Another aspect discloses an apparatus for modifying a balance of training data between classes for a machine learning model. The apparatus includes means for determining a factor for modifying a gradient based on a ratio of a number of examples of a class with a fewest members to a number of examples of a present class. The apparatus also includes means for modifying the gradient associated with the present class based on the determined factor.

Another aspect discloses wireless communication having a memory and at least one processor coupled to the memory. The processor(s) is configured to modify gradients of a backpropagation process while training the model, based on a ratio of a number of examples of a class with a fewest members to a number of examples of a present class.

Another aspect discloses a non-transitory computer-readable medium having non-transitory program code recorded thereon which, when executed by the processor(s), causes the processor(s) to perform operations of modifying gradients of a backpropagation process while training the model, based at least in part on a ratio of a number of examples of a class with a fewest members to a number of examples of a present class.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 illustrates a method for balancing training data according to aspects of the present disclosure.

FIG. 7 illustrates an overall example for balancing training data according to aspects of the present disclosure.

FIG. 8 illustrates a method for balancing training data according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Selective Backpropagation

Aspects of the present disclosure are directed to modifying the balance of training data between classes in a machine learning model. In particular, rather than manipulating the training data and adjusting a number of examples for each class at the input stage, aspects of the present disclosure are directed to adjustments at the gradient stage. In various aspects of the present disclosure, selective backpropagation is utilized to modify a cost function to adjust or selectively apply the gradients based on the class example frequency in the data sets. In particular, gradients may be adjusted based on the actual or expected frequency of examples for each class.

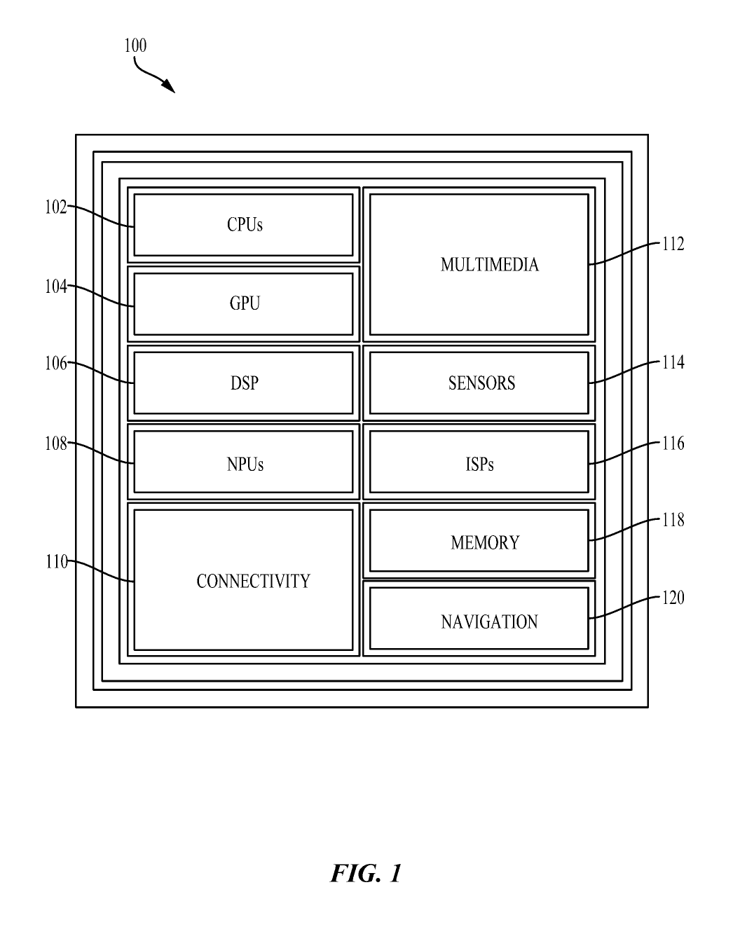

FIG. 1 illustrates an example implementation of the aforementioned selective backpropagation using a system-on-a-chip (SOC) 100, which may include at least one processor, such as a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for modifying gradients of a backpropagation process while training a machine learning model. The modifying is based on a ratio of a number of examples of a class with a fewest members to a number of examples of a present class. The modifying is applied to a gradient associated with the present class.

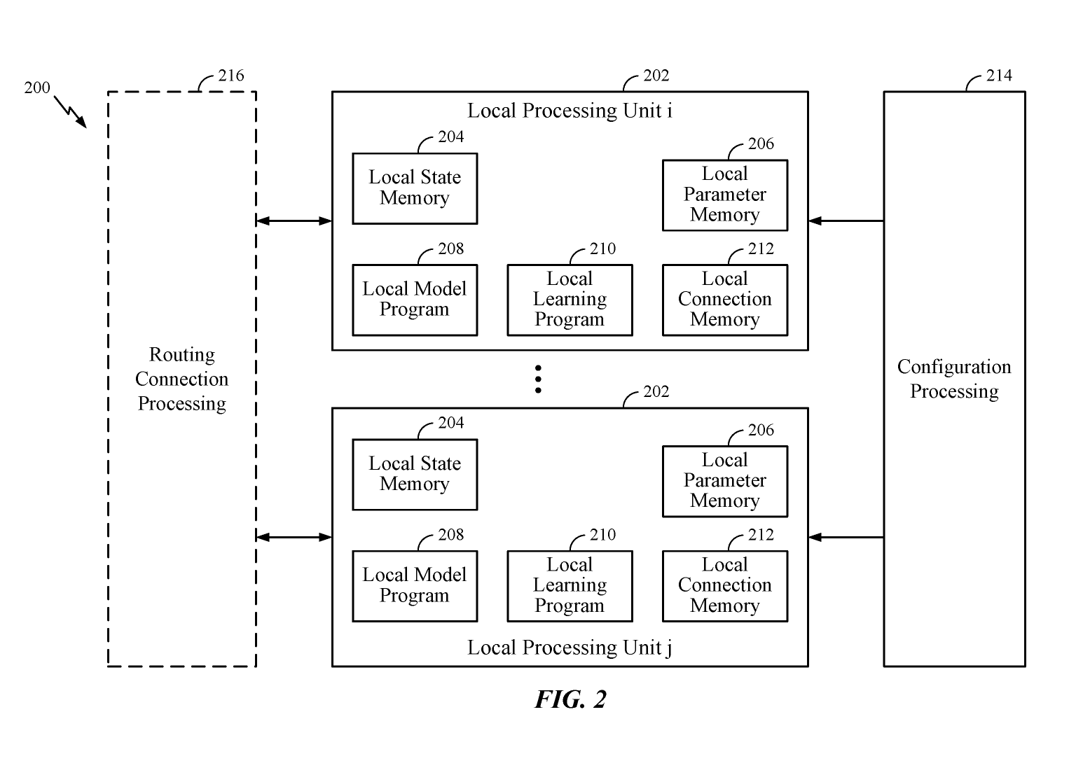

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

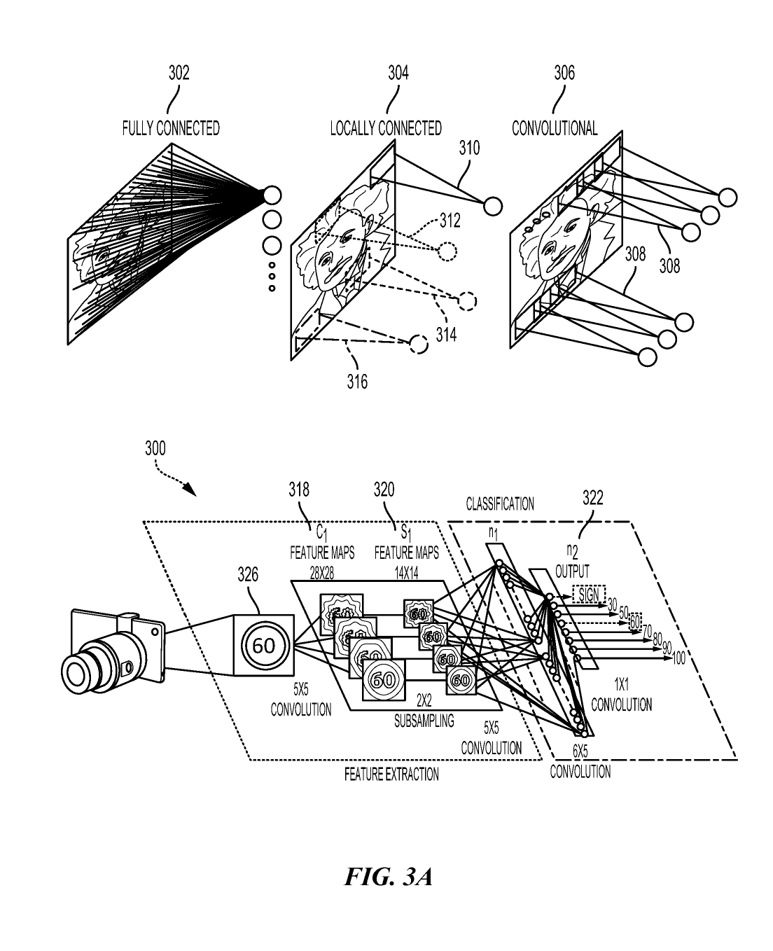

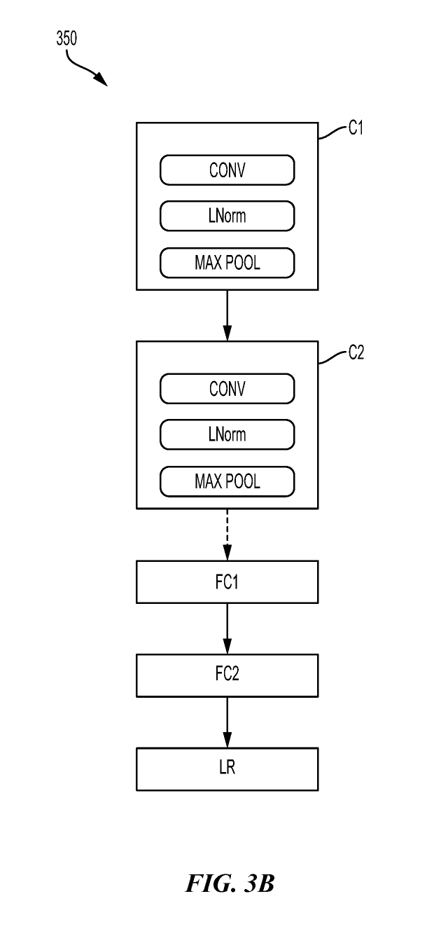

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “backpropagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

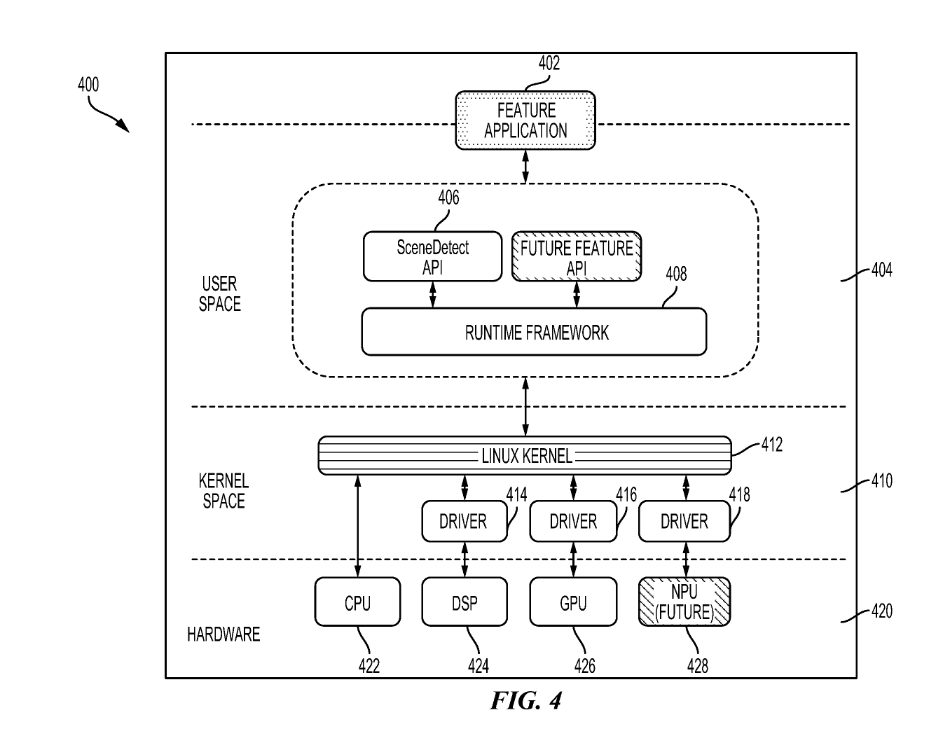

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

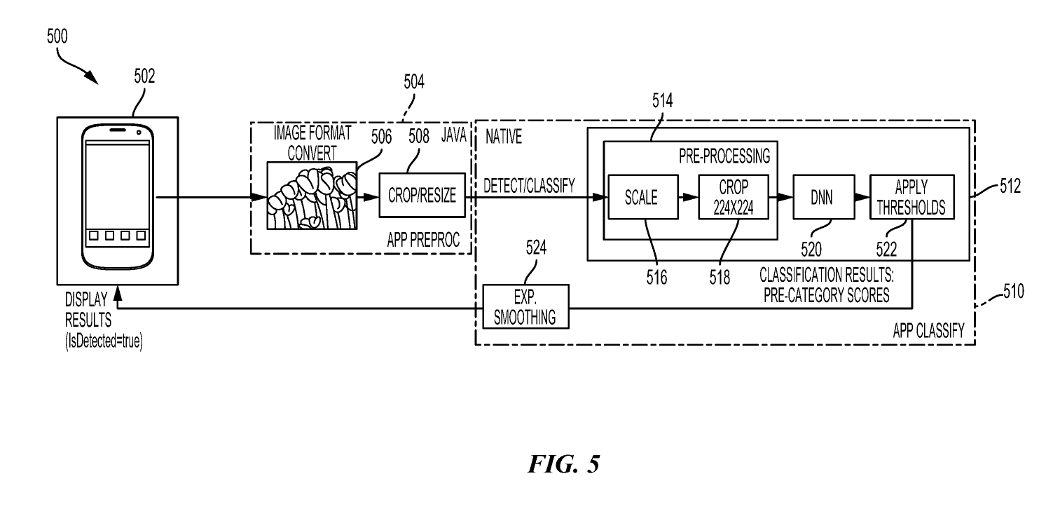

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

In one configuration, a machine learning model is configured for modifying gradients of a backpropagation process while training a machine learning model. The model includes means for modifying means, and/or means for determining. In one aspect, the modifying means, and/or determining means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

In another aspect, the modifying means may include means for scaling the gradient. Optionally, the modifying means may include means for selectively applying the gradient.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

In many machine learning processes, a cost function is used to quantify the error between a learned classification function's output and the desired output. A purpose of a machine learning process is to alter the parameters of the learned classification function to minimize this cost function. In classification problems, the cost function is often a log-probability penalty function of the actual class labels associated with some input and the predicted class labels achieved by applying the function to that input. Training is the process of altering the parameters of the learned classification function. During training, example inputs and their associated labels are presented to the machine learning process. The process finds the predicted label given the current learned classification functions parameters, evaluates the cost function, and alters the parameters of the learned classification function according to some update learning rule.

During the training process, the use of imbalanced training data may bias the classifier(s). Rules, such as “learning rules” may be utilized as an attempt to balance the training data such that there are approximately an equal number of examples of each class label. If the training data contains a large number of examples of one class and a small number of examples of another class, the parameters of the classification function are updated more often in a way that is biased toward the class with more numerous examples. In the extreme, if one is training a binary classifier with one million examples of the first class and only one example of the second class, the classifier will perform very well by simply always predicting the first class. In another example, a dog recognizer is being trained. In this example, the training data includes a thousand total examples, where 990 of the examples are dogs and 10 of the examples are cats. The classifier may learn to classify images as dogs, which will result in a high recall with a high precision on the training set. However, it is more likely the classifier has not learned anything.

Typically, the “balancing” of the training data between classes is addressed by ensuring the relative frequencies of training examples for each class match the relative frequency one expects to encounter when applying the classifier to new examples not used in training. However, this approach has several drawbacks. First, it assumes the relative frequencies of the class examples in a future dataset are known. However, this is not always easy to determine. Second, the training data may contain too many or too few examples of each class. To balance the training examples, data is either thrown away or repeated. By throwing away data, valuable training data may be excluded for some classes, which may prevent the classifiers from fully representing the input variations associated with that class. By repeating data in a straightforward way, much more disk space is used to stage the data. In particular, if the goal is to use all of the data, then every class would be repeated up to the least common multiple for perfect balance. Further, for multi-label data, where each example may be labelled as positive for two or more labels, balancing across all the labels becomes a complex scheduling exercise, and simple repetition may not suffice.

Aspects of the present disclosure are directed to balancing training data between classes in a machine learning model. In particular, rather than manipulating the training data and adjusting a number of examples for each class at the input stage, aspects of the present disclosure are directed to adjustments at the gradient stage.

Backpropagation, also referred to as the backward propagation of errors, may be utilized for computing gradients of a cost function. In particular, backpropagation includes determining how to adjust weight values to reduce the error closer to zero. In various aspects of the present disclosure, selective backpropagation is a modification to any given cost function to adjust or selectively apply the gradients based on the class example frequency in the data sets. After images have been input and the gradient is about to be applied to perform the backpropagation, the gradients may be adjusted based on the frequency of examples for each class.

In one aspect, the adjustment is related to a relative class frequency, f_{c}, which is a ratio of a minimum number of examples in a training data set (min_{C}N_{C}) to the number of all the examples in the training data set (N_{c}, e.g., number of examples of a class with the fewest members to a number of examples of a present class). The relative class frequency (also called a frequency factor) may be represented as:

$${f}_{c} = \frac{{min}_{ℂ} {N}_{c}}{{N}_{c}} ℂ ∋ all concepts \qquad ( 1 )$$

The minimum number of examples may be based on an actual or expected number. Further, the number of all examples in the training data set may be based on the actual number of an expected number of examples. Referring back to the cat/dog example where a dog recognizer is being trained, there are 990 examples of dogs and 10 examples of cats. The frequency factor for each class for the dogs is 10/990 where 10 is the minimum number of examples and 990 is the number of examples for your class. The factor for each class for cats is 10/10. The adjustment factor (e.g., the relative class frequency) is the value “1” for the class that has the minimum number of examples and may be less than one for all other classes.

Once the frequency factor is determined, the backpropagation gradient is modified. The modification may include scaling the gradient for each class. The scaling may be represented as:

$$Scaling \text{:} \frac{d {E}_{applied}}{d x} = {f}_{c} \frac{d E}{d x} \qquad ( 2 )$$

In the scaling implementation, the gradient may be multiplied by the frequency factor (e.g., the relative class frequency). The gradient is the derivative of the error with respect to a particular parameter. In an example where there are many examples of a certain class, only a fraction of the gradient is applied each time to prevent overlearning of that class. In the dog/cat example, where there are 10 examples of dogs in a row, then only a tenth of the gradient is applied. The goal is to prevent the model from overlearning and labelling all images as a dog because it has seen many more examples of dogs than cats. The scaling is applied equally to all gradients in all the weights of a particular class.

The modification may also include using the factor to sample from the images. The sampling may be represented as:

$$Sampling \text{:} \frac{d {E}_{applied}}{d x} = \{ \begin{matrix}O , & if s = O \\ \frac{d E}{d x} , & if s = 1\end{matrix} \qquad ( 3 )$$

Here, the gradient is selectively applied based on a sampling of the class examples. In one example, the sampling is randomly applied. The value of the scaling factor may be used as the probability parameter of a Bernoulli distribution from which samples are drawn. Sampling from this distribution produces either 0s or 1s with the probability of sampling a 1 being equal to the scaling factor described in the first method. For the class with the minimum number of examples, the sampling produces a 1. When the coin flip produces a 1, the error gradient for that class is backpropagated. When the coin flip produces a 0, the gradient for that class if not backpropagated, but effectively set to 0. In other words, images are sampled at the gradient stage to only sometimes send back the gradient when there are many examples. When there are a minimum number of examples, it is sent back every time. This provides for equalization of the examples from which the classifier is learning by adjusting the gradients rather than adjusting the input. In one aspect, before forward propagating an image, it is checked whether that class is set to use that image for the current epoch. For each epoch, the sets can be reshuffled.

The sampling may be applied on an individual basis, an epoch basis, or a training corpus basis. As presented above, in the individual basis, a random outcome is generated from the Bernoulli distribution for each image independent of the other images presented during a training epoch. Some epochs may see more or less than the desired number of examples for each class due to the random nature of the sampling.

For the epoch basis, the scale factor is randomly selected for each class from all class examples. A fixed number of examples are used for each class during each epoch. For example, ten (10) examples may be selected from each class. Only those examples are backpropagated during the particular epoch.

For the training corpus basis, a frequency factor is randomly selected for each epoch for each class from those that have not yet been presented to the classifier. The examples are sampled without replacement. In the following illustrative examples, there are 1000 dog examples, and in each epoch, 10 samples are randomly selected. In the first epoch, 10 examples are selected from the 1000 total examples. In the next epoch, the previously 10 selected examples are removed and 10 examples are selected from the remaining 990 examples. This continues until all of the examples have been exhausted, ensuring the same number of examples is used for each class during each epoch and that all available examples are used over the course of training. When cycling through the data the next time, the same order could be maintained or alternatively, a different order could be used. In another configuration, the examples are sampled with replacement.

In many cases, the entire training corpus is available before the start of training and the fc factors are static over the training session and may be calculated for each class before training begins. However, in cases where classes are added after training begins or the training examples are supplied ad hoc during training, the fc factors may be changing over time or unknown at the start of training. In this situation, a running count of the number of examples for each class (Nc) can be kept and updated after each example is presented. The fc factor is then calculated on the fly after each update to Nc for a particular class (c).

In another aspect, the relative frequency of a class (e.g., frequency factor) is utilized to equalize the amount of change in the network for each class and to ensure each class is relatively equally likely to be guessed by the classifier. The relative frequency class promotes a uniform distribution of classes in the data set. If there is a known expectation that there will be more of some classes than other classes, the frequency factor may be adjusted. For example, if it is known there are more cats than dogs in the real world, but the training data includes 1000 examples of dogs and 10 examples of cats, then the frequency factor may be adjusted to account for the real world expectation. If it is known that it is ten times more likely to see cats than dogs in the real world, the frequency factor may be multiplied by a factor of ten for cats and by a factor of one for dogs. Essentially, the frequency factor (Fc) may be manipulated at the learning stage to target a uniform expectation of what is present in the real world. The frequency factor may be adjusted as:

$${f}_{c} \frac{{min}_{ℂ} p ( c )}{p ( c )} \frac{{min}_{ℂ} {N}_{c}}{{N}_{c}} , \qquad ( 4 )$$

where p(c) is the expected probability of observing a particular class in the real world (or “wild”).

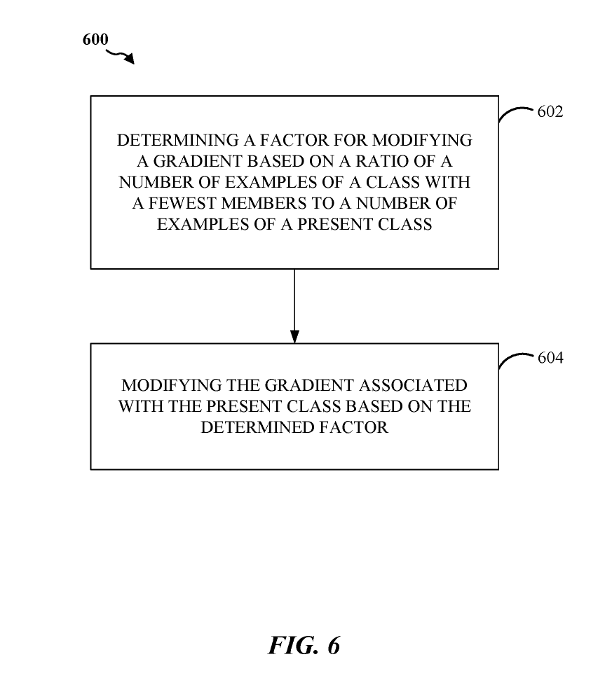

FIG. 6 illustrates a method 600 for balancing training data between classes for a machine learning model. In block 602, the process determines a factor for modifying a gradient based on a ratio of a number of examples of a class with a fewest members to a number of examples of a present class. The fewest members may be based on the number of actual or expected members. Likewise, the number of examples of a present class may be based on the actual or expected number of examples. In block 604, the process modifies the gradient associated with the present class based on the determined factor.

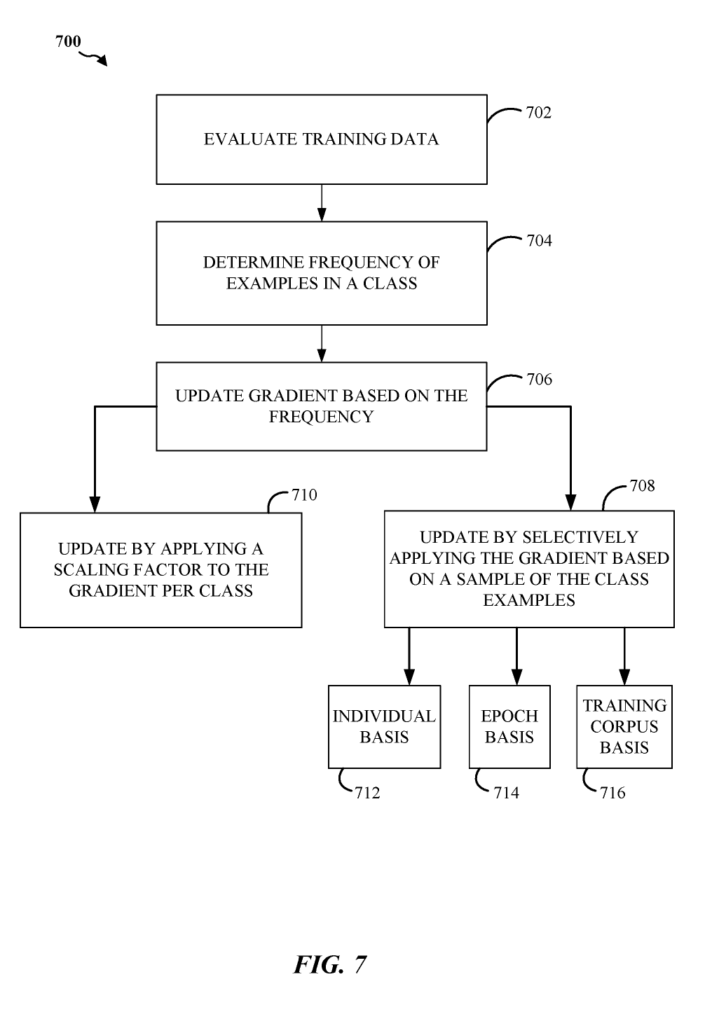

FIG. 7 illustrates an overall method 700 for balancing training data between classes for a machine learning model. In block 702, the training data is evaluated. In block 704, the frequency of examples in a class is determined. In block 706, the gradient is updated based on the determined frequency. The update may be performed by applying a scaling factor to the gradient for each class at block 710. Alternately, the update may be performed by selectively applying the gradient based on a sample of the class examples at block 708. The selectively sampling update may be performed on an individual basis at block 712, epoch basis at block 714 or training corpus basis at block 716.

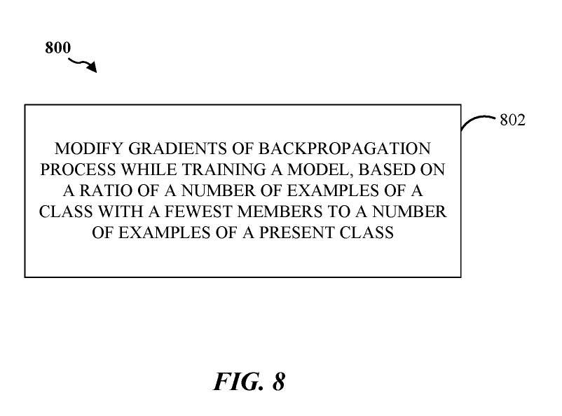

FIG. 8 illustrates a method 800 for balancing training data according to aspects of the present disclosure. In block 802, the process modifies gradients of a backpropagation process while training the model. The modification is based on a ratio of a number of examples of a class with a fewest members to a number of examples of a present class.

In some aspects, methods 600, 700, and 800 may be performed by the SOC 100 (FIG. 1) or the system 200 (FIG. 2). That is, each of the elements of methods 1100 and 1200 may, for example, but without limitation, be performed by the SOC 100 or the system 200 or one or more processors (e.g., CPU 102 and local processing unit 202) and/or other components included therein. In some aspects, the methods 600 and 700 may be performed by the SOC 420 (FIG. 4) or one or more processors (e.g., CPU 422) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of modifying a balance of training data between classes for a machine learning model, comprising:
modifying gradients of a backpropagation process while training the model, based at least in part on a ratio of a number of examples of a class with a fewest members to a number of examples of a present class.

2. The method of claim 1, in which the modifying comprises scaling the gradient.

3. The method of claim 1, in which the modifying comprises selectively applying the gradient based at least in part on a sampling of the class examples.

4. The method of claim 3, in which the sampling of the class occurs by selecting a fixed number of examples from each training epoch.

5. The method of claim 1, in which the sampling occurs without replacement of examples in a training epoch.

6. An apparatus for modifying a balance of training data between classes for a machine learning model, comprising:
means for determining a factor for modifying a gradient based at least in part on a ratio of a number of examples of a class with a fewest members to a number of examples of a present class; and
means for modifying the gradient associated with the present class based on the determined factor.

7. The apparatus of claim 6, in which the modifying means comprises means for scaling the gradient.

8. The apparatus of claim 6, in which the modifying means comprises means for selectively applying the gradient based at least in part on a sampling of the class examples.

9. The apparatus of claim 8, in which the sampling of the class occurs by selecting a fixed number of examples from each training epoch.

10. The apparatus of claim 6, in which the sampling occurs without replacement of examples in a training epoch.

11. An apparatus for modifying a balance of training data between classes for a machine learning model, comprising:
a memory; and
at least one processor coupled to the memory, the at least one processor configured to modify gradients of a backpropagation process while training the model, based at least in part on a ratio of a number of examples of a class with a fewest members to a number of examples of a present class.

12. The apparatus of claim 11, in which the at least one processor is configured to modify by scaling the gradient.

13. The apparatus of claim 11, in which the at least one processor is configured to modify by selectively applying the gradient based at least in part on a sampling of the class examples.

14. The apparatus of claim 13, in which the sampling of the class occurs by selecting a fixed number of examples from each training epoch.

15. The apparatus of claim 11, in which the sampling occurs without replacement of examples in a training epoch.

16. A non-transitory computer-readable medium for modifying a balance of training data between classes for a machine learning model, the non-transitory computer-readable medium having program code recorded thereon, the program code comprising:
program code to modify gradients of a backpropagation process while training the model, based at least in part on a ratio of a number of examples of a class with a fewest members to a number of examples of a present class.

17. The non-transitory computer-readable medium of claim 16, in which the program code to modify comprises program code to scale the gradient.

18. The non-transitory computer-readable medium of claim 16, in which the program code to modify comprises program code to selectively apply the gradient based at least in part on a sampling of the class examples.

19. The non-transitory computer-readable medium of claim 18, in which the sampling of the class occurs by selecting a fixed number of examples from each training epoch.

20. The non-transitory computer-readable medium of claim 16, in which the sampling occurs without replacement of examples in a training epoch.
